(19) United States
(12) Patent Application Publication
(10) Pub. No.: US 2005/0115821 A1
(43) Pub. Date: Jun. 2, 2005

(54) Production of nanotubes

(76) Inventors: Xu Shi, Ayer Rajah Industrial Estate (SG); Gao Qing Max Lu, Queensland (AU)

Correspondence Address: STERNE, KESSLER, GOLDSTEIN & FOX PLLC, 1100 NEW YORK AVENUE, N.W., WASHINGTON, DC, 20005, US

(21) Appl. No.: 10/502,956

(22) PCT Filed: Feb. 3, 2003
(86) PCT No.: PCT/GB03/00435

(30) Foreign Application Priority Data
Feb. 1, 2002 (GB) 0202397.6

(51) Int. Cl. B01J 19/08; C01B 31/00

(52) U.S. Cl. 204/164; 423/445 R; 422/186.04

(57) ABSTRACT

Apparatus for production of carbon nanotubes comprises a vacuum chamber, electrodes and a power supply to form an arc between the electrodes together with a conduit that extends into the vacuum chamber from the outside and enables graphite powder to be introduced directly into the arc formed between the electrodes. A feeder is provided to feed an anode into the chamber. In one embodiment, the electrodes include a plurality of anodes arranged in an array. The cathode is arranged to be rotatable with a trimmer to remove debris from the cathode surface. Methods of production of nanotubes using the apparatus are also provided.

The present invention relates to production of carbon nanotubes. In particular, the present invention relates to production of carbon nanotubes in a plasma arc.

Since their discovery in 1991, carbon nanotubes have attracted significant interest for their many potential applications, most of which derive from their unusual structural and electronic properties. Carbon nanotubes can be both multi-walled and single-walled, the latter form attracting particular interest in a wide variety of technology areas, including in particular as a diagnostic reagent and, most recently, for hydrogen storage.

Synthesis of carbon nanotubes is described by Shi et al in the Journal of Physics and Chemistry of Solids, 61 (2000) pp 1031-1036. Shi et al used an arc discharge method to produce single-walled carbon nanotubes from a graphite anode, a 10 cm anode rod being spent in 2 hours to yield 5 g of soot.

Ando et al, in Diamond and Related Materials, Volume 10 (2001), pages 1185-1189 used a DC arc plasma jet to form single-walled carbon nanotubes using pure graphite cathode and anode rods. The cathode and anode were oriented at approximately 600 to improve yield of single-walled nanotubes.

Both Shi et al and Ando et al focus on improving the yield of single-walled carbon nanotubes. Ando et al adjusted the angle between the cathode and anode rods, reducing the deposit formed on the cathode and increasing the yield. Shi et al investigated the role of different catalysts and also the role of helium pressure. A common difficulty in these respective investigations is that the methods described are not suitable for long term operation and long term carbon nanotube production. The methods also produce relatively low amounts of carbon nanotubes, and hence represent methods that are not suitable for scaled-up production. Where anodes are consumed in the process these have to be replaced after a given life time. Change in catalyst structure and content can result in change in yield of single-walled nanotubes, but there is a limit to the yield improvements that can be achieved merely by catalyst alterations.

It is known from WO 01/79113 to prepare fullerenes such as nanotubes from methane gas, though improved formation of single-walled nanotubes would be desirable.

Vacuum arc processes and apparatus therefor are well known in the art. By way of example, DE 4100541 C describes an apparatus suitable for vaporisation of a material by means of a vacuum arc discharge with a cold cathode and a hot self-consuming anode. U.S. Pat. No. 5,441,624 describes a low current anodic vacuum arc assembly, comprising a continuous, consumable anode. U.S. Pat. No. 5,441,617 describes an anodic arc deposition assembly including a material recovery system for recovery of anodic arc deposition coating material.

GB 832946 A describes an apparatus for the manufacture of hydrocyanic acid with ‘two or more pairs of arc electrodes’. GB 763446 A describes methods for increasing the yields of the photochemical reaction of organic compounds using reaction tubes with a ‘plurality of spaced apart anodes’. U.S. Pat. No. 5,441,624 describes a low current anodic vacuum deposition system. U.S. Pat. No. 3,931,542 describes an apparatus for energising materials in a free-burning electric arc comprising a plurality of anodes around an extension of a cathode axis. There is no mention in these documents, however, of production of carbon nanotubes.

It is an object of the present invention to provide method and apparatus for production of carbon nanotubes in high yield. Another object is to enable production of carbon nanotubes in apparatus that can operate for long periods of time and, desirably, near continuously. An object of a specific embodiment of the invention is to provide a further means of obtaining high yields of single-walled carbon nanotubes.

Accordingly, the present invention provides, in a first aspect, a method of manufacture of carbon nanotubes, said nanotubes being formed from graphite powder in an arc between electrodes in a vacuum chamber, wherein the graphite powder is introduced into the arc via a conduit extending into the arc from outside the vacuum chamber.

An advantage of the method is that the consumed material, graphite in the powder, can be introduced continuously into the nanotube production process, enabling increased production time. There is reduced wear of the electrodes, which typically are or comprise graphite and hence the electrodes have a longer lifetime.

It is especially suitable for the graphite powder to be introduced into the arc via a conduit in one of the electrodes. Thus, the powder may be fed directly to the desired location. In an embodiment of the invention the conduit is in the anode, and a particular anode described in the examples below comprises a substantially circular, substantially central bore and the method comprises introducing graphite powder into the arc via the bore.

The graphite powder may be substantially pure graphite or may optionally include a catalyst for nanotube production. A number of different catalysts are known for use in nanotube production and all are suitable for production of carbon nanotubes from graphite powder according to the present invention. The catalyst may be mixed into the graphite powder, included in a gas stream, included as a component of one or more of the electrodes or may be introduced independently into the arc. It is particularly convenient for the catalyst to be mixed into the graphite powder so that it can be fed into the arc at the same time as the powder. Catalysts are described in the art, and include for example Ni- and Co- based catalysts, sometimes doped for example with Y. Similarly, if a graphite electrode is used it may be pure or may contain catalyst. The electrodes can be of other materials and do not necessarily have to be or comprise graphite—this is another benefit of the invention, in that it is powder fed into the arc that is the major component that is consumed and not the electrodes, thus allowing use of material other than graphite for those electrodes.

In use of the invention, graphite powder is introduced into the arc in combination with a gas, the gas being used to propel the powder along the conduit and into the arc in the chamber. The dimensions of the conduit are such as to allow the powder to flow, whilst at the same time being sufficiently small that the gas will force the powder along the conduit and out of an opening at the end of the anode and into the arc.

The pressure inside the vacuum chamber is significantly below atmospheric, and importantly there should be no oxygen present for this would lead to combustion or other difficulties. Hence, in operation the vacuum chamber is first evacuated and often also purged of any residual oxygen.

During operation, the pressure in the vacuum chamber is typically between 400 and 700 Torr, and the gas in the chamber may comprise Ar, CH₄, He, H₂, other inert gases and/or mixtures thereof.

To supply graphite powder and gas into the vacuum chamber, the pressure in the anode manifold is generally greater than that in the vacuum chamber and generally greater than atmospheric. A pressure of around 800 Torr or more has been found sufficient to blow powder out of the anode nozzles and in to the arc.

The gas used is inert to the arc, and gases commonly used in this technology and which are suitable for the invention include methane, helium, argon, hydrogen, another inert gas, or mixtures thereof. If methane or another carbon-containing or hydrocarbon-containing gas is used then carbon in the gas can also contribute to formation of nanotubes in the arc.

Also provided by this aspect of the invention is apparatus for production of carbon nanotubes, comprising:—a vacuum chamber;
electrodes in the vacuum chamber;
a power supply to form an arc between the electrodes; and
a conduit extending from outside the vacuum chamber into the vacuum chamber and for introduction of graphite powder into the arc.

The conduit may be located in, or in at least a part of, an electrode, suitably an anode.

The apparatus may also comprise a container to receive graphite powder, a supply of gas and apparatus to feed a mixture of the gas and the graphite powder into the arc via the conduit. In use, an amount of powder is loaded to the container and combined with gas from the gas supply which forces the powder through the conduit and into the arc between the electrodes. Nanotubes may be continuously formed whilst the supply of powder is maintained.

A second aspect of the invention also addresses the problem of enabling long term operation of nanotube manufacture. Accordingly, the invention additionally provides apparatus for production of carbon nanotubes from graphite powder, comprising:—
a vacuum chamber;
electrodes comprising an anode and a cathode;
a power supply to form an arc between the anode and the cathode; and
an anode feeder to feed the anode into the vacuum chamber.

Preferably, in combination with the feeder there is provided some means of determining whether and/or to what extent it is needed to feed the anode into the chamber. One suitable device is a detector to monitor consumption of the anode. Upon consumption of anode beyond a predetermined point the feeder may operate automatically to introduce more anode into the chamber. Alternatively, the detector may be passive, indicating for example the location of the end of the anode and leaving feeding of the anode to an operator. The detector may for example monitor arc current or the separation between the anode and the cathode.

The anode feeder can advantageously be used in combination with the conduit of the invention. Despite supplying consumable materials via a conduit in the anode, consumption of the anode in the apparatus of the invention may nevertheless occur. The feeder enables the anode to be fed into the vacuum chamber to compensate for this consumption and enable long term operation of the apparatus.

An option to monitor the separation of the anode from the cathode is to monitor the voltage of the DC power supply. Using a constant current mode, a higher voltage indicates a greater separation of the electrodes and a need to feed one or both of them, either together or independently, until a suitable voltage is reached.

A further object of the invention is to enable increased production of nanotubes from a given vacuum chamber. A third aspect of the present invention provides apparatus for production of carbon nanotubes, comprising:—
a vacuum chamber;
electrodes in the vacuum chamber; and
a power supply to form an arc between the electrodes;
wherein the electrodes comprise at least a cathode and a plurality of anodes.

As shown in an example below, the plurality of individual anodes can be arranged in an array, preferably a regular array, and thus efficiently utilize the space available within the chamber. The many anodes provide additional arcs or additional arc space within which and/or associated with which nanotubes may be formed and thus the production capacity of the apparatus is greatly improved compared with prior apparatus.

Multiple anodes can be arranged into groups and even subgroups, each anode separated from the others at its end which in the vacuum chamber is situated proximally to a or the cathode. The array will typically comprise at least two rows of anodes and at least two columns of anodes. Parallel anode rods is a suitable arrangement, with the spacing of the rods maintained along their length. The rods may be formed for example into a pattern with rods evenly spaced and, for example, in a square, rectangular, triangular or circular pattern.

The apparatus suitably operates using a direct current (DC) power supply, as a DC arc is generally fairly easy to control. Its power, however, is limited at the present time and continuous DC power supplies are generally limited to about 250 A. An advantage of the apparatus of the invention is that multiple power supplies can be used simultaneously, either one supply for each anode rod or one power supply for each sub-group of rods.

In a specific embodiment of the invention there are provided a plurality of power supplies for the anodes. One power supply may be connected to each anode or, if the anodes are divided into sub-groups, to the anodes of a sub-group. By way of illustration, with a 250 A DC supply, each rod in a group of 5 can receive 50 A.

A specific embodiment of the invention illustrates five separate anodes in an array. A specific anode that has been operated successfully is approximately 12 mm wide with a central bore between 1 and 2 mm in diameter. This bore is dimensioned so as to be sufficiently wide for powder to be delivered through the bore whilst at the same time enabling a sufficiently high flow of gas to carry the powder, this latter requirement tending the hole towards being not too large.

Typically the anodes are graphite rods, optionally made containing catalyst and optionally pure graphite.

In operation, a plume of plasma generally forms between the anode and the cathode and is often around 10-15 mm in size. In embodiments of the invention, the spacing between the individual anode rods is approximately of this same dimension, namely from 10-15 mm. The size of the plume can depend upon the angle between the anode and cathode. The angle provides space for the plume to escape, and generally an angle of around 45°, typically between 30 and 60° produces sufficient space.

The separation of the respective anode rods can thus be chosen so that the respective plasma plumes overlap with each other.

In use, carbon nanotubes formed in one arc may pass via gravity through the plume of an adjacent plasma plume. This increased exposure to the plasma arc is believed to effect the structure of the carbon nanotube formed, generally favouring formation of single-walled nanotubes.

The apparatus of this aspect may advantageously be combined with the anode feeder and/or the powder conduit aspects as described herein.

Further, this aspect provides a method of production of carbon nanotubes comprising forming, simultaneously and in the same vacuum chamber, a first arc between a cathode and a first anode and a second arc between a cathode and a second anode, the cathode in each case being either the same or different. In operation, carbon nanotubes can be formed from graphite powder introduced into the vacuum chamber, especially by introducing the graphite powder into the first arc via a conduit in the first anode and introducing the graphite powder into the second arc via a conduit in the second anode.

A yet further problem addressed in the present is that of damage to the cathode during nanotube production. Accordingly, a fourth aspect of the invention provides apparatus for production of carbon nanotubes, comprising:—
a vacuum chamber;
an anode;
a cathode; and
a power supply,
wherein the cathode is rotatable.

The fourth aspect of the invention additionally provides apparatus for production of carbon nanotubes, comprising:—
a vacuum chamber;
an anode;
a cathode;
a power supply; and
a cutter to trim debris from the cathode.

Rotation of the cathode, whether during or between arc formation is a particular advantage in that it promotes even utilization of the cathode. This utilization is not limited to consumption of the cathode material but also extends to build up of deposits on the cathode and damage to the surface leading for example to uneven wear. All of these events are detrimental to long term operation and are reduced by rotation of the cathode.

Using a cutter to trim debris from a surface of the cathode allows maintenance in situ of the cathode, avoiding the disruption that is caused by breaking vacuum and removing the cathode or attending to its upkeep whilst the apparatus is not being used for nanotube production.

Preferably, the cutter and rotation of the cathode are both combined in the apparatus, rotation facilitating even trimming of the surface and enabling a portion of the cathode to be arcing with an anode whilst another portion of the cathode is being trimmed.

Reference to debris is intended to include deposits, wear of the surface leading to uneven portions as well as some nanotube products which may lodge on the cathode and hinder its continued operation or otherwise reduce efficiency of the production. The cutter may also be used in combination with a feeder that feeds the cathode into the chamber. The feeder can be operated so as to compensate for cathode material consumed, and the trimmer can be used to trim the surface of the fed cathode, allowing an operator to maintain the cathode is good condition for extended periods of use.

Prior art cathodes in this technology are generally graphite rods of even diameter along their whole length. A cathode for the apparatus of the invention suitably comprises a wide, substantially planar surface at the end proximal to the anode, and between which surface and the anode is formed the arc. Preferably, the cathode is circular in cross section, having a narrow stem and an enlarged head, the head being proximal to the anode and hence being wide and planar in construction. The cathode is preferably T-shaped when viewed from the side. An appropriate dimension for the stem of the cathode is up to 3 cm in diameter and for the head of the cathode is at least 4 cm in diameter.

An advantage of the cathode of the invention is that a large surface area is presented for formation of an arc with the anode. This large surface area means that there is more material in the cathode at the point, with the result that consumption of the cathode when measured by distance is reduced. This prolongs the life of the cathode. The large size, as discussed above, also means that one part of the cathode surface proximal to the anode can be arcing whilst another, distal from the anode, is, for example, being trimmed or otherwise maintained.

A particularly suitable cathode is a graphite disk, optionally containing catalysts and optionally pure graphite, of around 30 cm in diameter.

The fourth aspect thus further provides a method of production of carbon nanotubes comprising:—
forming carbon nanotubes in an arc between a cathode and an anode in a vacuum chamber; and
trimming debris from a surface of the cathode without breaking vacuum in the chamber.

The apparatus can operate simultaneously to form carbon nanotubes and trim debris from the surface of the cathode.

Whilst the aspects of the invention have been described individually, specific embodiments of the invention comprise all combinations of these aspects.

There now follows description of specific examples of the invention, illustrated by drawings in which:—

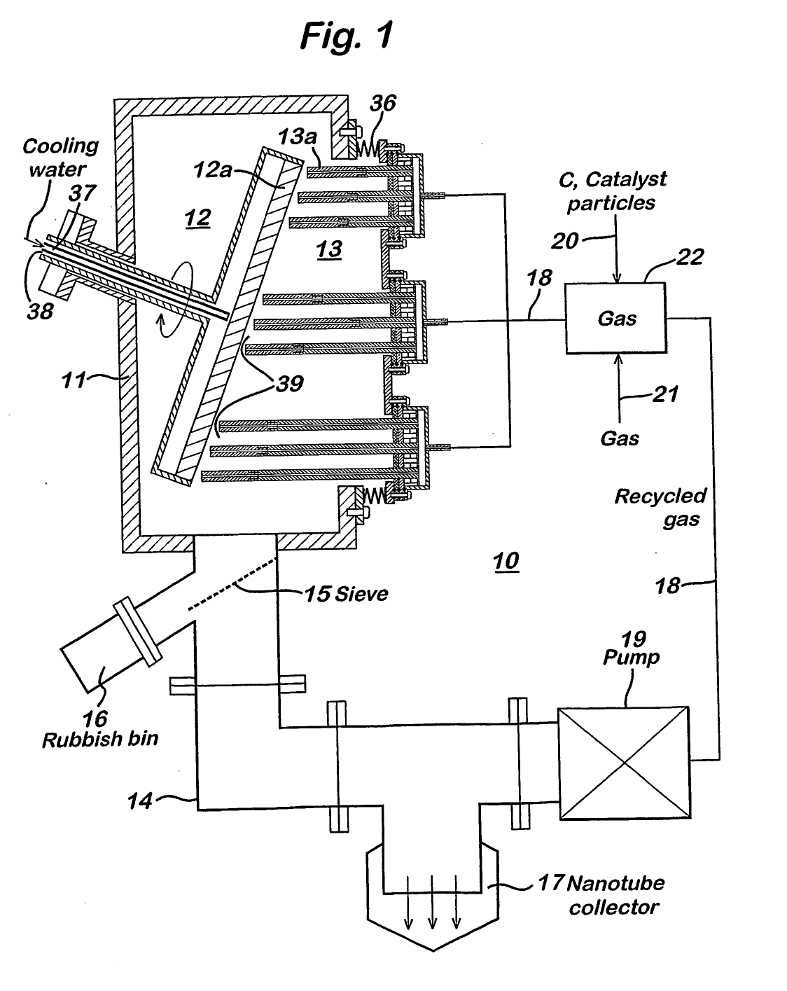

FIG. 1 shows a schematic diagram of apparatus for production of carbon nanotubes; and

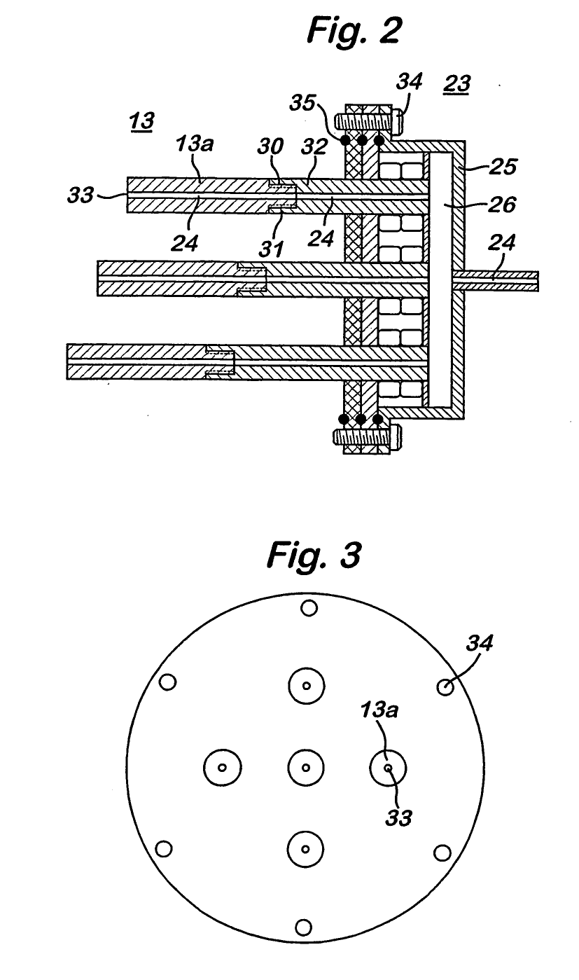

FIG. 2 shows a schematic side-view of an anode manifold for the apparatus; and

FIG. 3 shows a schematic end view of the manifold of FIG. 2.

### EXAMPLE

Referring to FIGS. 1, 2 and 3, a system for production of carbon nanotubes is shown generally as 10 and comprises a vacuum chamber 11 incorporating a direct current power supply (not shown) connected to the cathode assembly 12 and the anode array 13 which is made up of three groups of three anode rods 13a. Underneath the anode and cathode is an exit to a collecting duct 14 and a sieve 15 which separate the output into waste to be passed to waste collector 16 and nanotubes to be passed to nanotube collector 17.

The duct is connected to pump 19 which recycles gas via gas lines 18 to the powder feeding unit 22 and then via further gas lines 18 on to the anode array 13. Graphite powder is supplied via line 20 and replacement gas via line 21 to the feeder 22.

An anode manifold is shown generally as 23 and is made up of anode rods 13a with screw fitting ends 30 screwed into corresponding screw fitted ends 31 of anode bases 32. Conduit 24 at the end of the supply line 18 that connects to the manifold base 25 is continuous through plenum 26 of the manifold and into the anode bases 32 and then through the anode rod as conduit 24 to the anode nozzle 33.

The manifold and its component parts are held together via pins 34 and incorporate sealing rings 35. Vacuum bellows 36 in conjunction with a manifold feeder (not shown) allow the anode arrays to be fed into the vacuum chamber.

Cooling water for the cathode is supplied via cooling line 37 and exit line 38. Cooling is also provided for the anode but is not shown in the figures.

In use, a vacuum pump is started to evacuate the chamber and bring the pressure down to 10⁻² Torr or below. The anode is brought momentarily into contact with the cathode, or a high voltage is momentarily applied, so that an arc is established in arc space 39 between the anode arrays 13 and the graphite disk 12a of the cathode. Graphite powder containing analyst is fed into the chamber under a pressure of around 600 Torr of helium gas via lines 18 and conduit 24, thus being fed directly into arc space 39. Carbon nanotubes are formed in the arc in the arc space and nanotubes fall under gravity towards the exit of the vacuum chamber and the sieve 15, some falling directly towards the sieve and others passing through adjacent arc spaces on their descent. Nanotubes formed in this way may thus pass through a number of arc spaces and thus encounter arc conditions on a number of occasions before exiting the vacuum chamber. The arc voltage is monitored so the gap between the anode and cathode can be controlled.

The sieve 15 enables large particles (>10 μm diameter) to be transferred to a waste collector 16 whilst allowing smaller, desired product to continue to the nanotube collector 17. Gas is recycled via pump 19 and returned to the powder feeding unit. As necessary, further gas is introduced via line 21 to maintain an appropriate feed pressure of gas to propel the graphite powder into the arc space, the pressure typically being around 600 Torr.

The anode rods 13a of the anode array are offset slightly one from another. This enables there to be an angle between the longitudinal axis of the anode rods and the surface of the cathode, this angle being suitable to allow the plasma jet to form slightly to one side, such an arrangement being found to promote formation of single walled nanotubes. The anodes are further arranged that the arc between one anode and the cathode is adjacent to and overlaps with the arc between the adjacent anode and the cathode. The cathode is rotatable, in the direction shown by the arrow. A cutter to trim debris from the cathode surface is provided, though not shown in the figures.

The invention thus provides method and apparatus for production of carbon nanotubes.

1. A method of manufacture of carbon nanotubes, said nanotubes being formed from graphite powder in an arc between electrodes in a vacuum chamber, wherein the graphite powder is introduced into the arc via a conduit extending into the arc from outside the vacuum chamber.

2. The method of claim 1 wherein the graphite powder is introduced into the arc via a conduit in one of the electrodes.

3. The method of claim 2 wherein the graphite powder is introduced into the arc via a conduit in an anode.

4. The method of claim 3 wherein the anode comprises a substantially circular, substantially central bore and the method comprises introducing graphite powder into the arc via the bore.

5. The method of claim 2 wherein the graphite powder comprises a catalyst.

6. The method of claim 1 wherein the electrodes are graphite electrodes.

7. The method of claim 2 wherein the graphite powder is introduced into the arc in conjunction with a gas.

8. The method of claim 7 wherein the gas is selected from the group consisting of methane, helium, argon, hydrogen, another inert gas, and mixtures thereof.

9. Apparatus for production of carbon nanotubes, comprising:
a vacuum chamber,
electrodes in the vacuum chamber,
a power supply to form an arc between the electrodes; and
a conduit extending from outside the vacuum chamber into the vacuum chamber and for introduction of graphite powder into the arc.

10. The apparatus of claim 9, wherein the conduit is located in, or in at least a part of, an electrode.

11. The apparatus of claim 10 wherein the conduit is in, or is at least in part of, an anode.

12. The apparatus of claim 10 further comprising a container to receive graphite powder, a supply of gas and apparatus to feed a mixture of the gas and the graphite powder into the arc via the conduit.

13. Apparatus for production of carbon nanotubes from graphite powder, comprising:
a vacuum chamber,
electrodes comprising an anode and a cathode,
a power supply to form an arc between the anode and the cathode; and
an anode feeder to feed the anode into the vacuum chamber.

14. The apparatus of claim 13 comprising a detector to monitor consumption of the anode.

15. The apparatus of claim 14 wherein the detector monitors arc current.

16. The apparatus of claim 14 wherein the detector monitors the separation between the anode and the cathode.

17. The apparatus of claim 13 further comprising a conduit for introduction of graphite powder into the arc from outside the vacuum chamber and in accordance with claim 9.

18. Apparatus for production of carbon nanotubes, comprising:
a vacuum chamber,
electrodes in the vacuum chamber, and
a power supply to form an arc between the electrodes;
wherein the electrodes comprise at least a cathode and a plurality of anodes.

19. The apparatus of claim 18, comprising a plurality of individual anodes, arranged in an array.

20. The apparatus of claim 19, wherein the array of anodes comprises at least two rows of anodes and at least two columns of anodes.

21. The apparatus of claim 20, comprising a plurality of anodes which are substantially evenly spaced from one another.

22. The apparatus of claim 18 comprising a plurality of anodes arranged in a pattern representing a square, rectangular, triangular or circular pattern.

23. The apparatus of claim 18 comprising a separate power supply for each anode.

24. The apparatus of claim 18 wherein each anode comprises a conduit for introduction of graphite powder into the arc from outside the vacuum chamber in accordance with claim 11.

25. The apparatus of claim 18 further comprising an anode feeder according to claim 13.

26. The method of claim 3 comprising forming, simultaneously and in the same vacuum chamber, a first arc between a cathode and a first anode and a second arc between a cathode and a second anode, the cathode in each case being either the same or different,
forming carbon nanotubes from graphite powder introduced into the vacuum chamber,
introducing the graphite powder into the first arc via a conduit in the first anode and introducing the graphite powder into the second arc via a conduit in the second anode.

27-28. (canceled)

29. Apparatus for production of carbon nanotubes, comprising:
a vacuum chamber,
an anode,
a cathode; and
a power supply,
wherein the cathode is rotatable.

30. The apparatus of claim 29 comprising a cutter to trim debris from a surface of the cathode.

31. The apparatus of claim 30 wherein the cathode comprises a first portion and a second portion and wherein an arc can be formed between the first portion of the cathode and the anode whilst the cutter is trimming debris from the second portion of the cathode.

32. The apparatus of claim 31 wherein the cathode comprises a wide, substantially planar surface.

33. The apparatus of claim 32 wherein the cathode is circular in cross section.

34. The apparatus of claim 33 wherein the cathode comprises a narrow stem and an enlarged head.

35. The apparatus of claim 34 wherein the stem of the cathode is up to 3 cm in diameter and the head of the cathode is at least 4 cm in diameter.

36-38. (canceled)
